(19) United States
(12) Patent Application Publication
(10) Pub. No.: US 2026/0187935 A1
(43) Pub. Date: Jul. 2, 2026

(54) REMOTE APPAREL FITTING WITH TRANSFER OF GARMENT FIT AND STYLE

(71) Applicant: SpreeAI Corporation, Incline Village, NV (US)

(72) Inventors: Minh Phuoc Vo, Alameda, CA (US); Vinh Quang Tran, Woodside, NY (US); Chi Nhan Duong, Quebec (CA); Bo Kyung Kim, Brooklyn, NY (US); Tiffany Seojin Kwak, Lawrenceville, GA (US); Danel Dominguez Sullivan, San Diego, CA (US)

(73) Assignee: SpreeAI Corporation, Incline Village, NV (US)

(21) Appl. No.: 19/003,483

(22) Filed: Dec. 27, 2024

(51) Int. Cl. G06T 19/00; G06T 7/50; G06T 7/60; G06T 17/20

(52) U.S. Cl. CPC G06T 19/00; G06T 7/50; G06T 7/60; G06T 17/20; G06T 2207/20081; G06T 2207/20084; G06T 2207/30196; G06T 2210/16

(57) ABSTRACT

In one implementation of remote apparel fitting, a processing device receives a first image of a subject person and a selection of a clothing item. A first machine-learning model uses the first image to determine measurements of the subject person. A second machine-learning model then determines the fit of the clothing item on the subject person based on a second image of the clothing item worn by another person and the measurements of the subject person. The fit of the clothing item includes one or more of a garment length, a relative size of the clothing item on the other person, a draping of the clothing item on the other person, tucked in versus untucked, or sleeves rolled up versus unrolled. The processing device then displays a third image of a portrayal of the subject person wearing the clothing item with the fit portrayed in the second image.

### BACKGROUND

Clothing fit can vary significantly across different brands, and even within the same brand. For example, a particular shirt may be intended to fit loosely on the shoulders and tightly on the waist. A similar shirt from the same brand may be intended to fit tightly throughout. This means that a person might like the fit and appearance a particular clothing item as it appears on a model or mannequin but does not know if the clothing item will have the same fit and appearance on them. Traditionally, shoppers dealt with this issue by trying on clothing items in physical retail locations such as department stores. However, with the increasing trend of online purchasing, people have lost the assurance of confidently selecting clothing items that fit well and appear as desired.

### SUMMARY

Techniques and systems for remote apparel fitting with the transfer of garment fit and style are described. In one example, a processing device receives an input image of a subject person (e.g., an online shopper) and a selection of a clothing item. The input image preferably depicts the subject person from a front-or side-facing perspective. For example, the person is browsing an online catalog of clothing items and trying to find clothing items (e.g., shirts) that fit well. A first machine-learning model uses the input image to determine measurements of the subject person that correlate to one or more dimensions of the clothing item. In some implementations, the first machine-learning model determines the measurements after generating a mesh model of the subject person.

A second machine-learning model then determines the fit of the clothing item on the subject person based on a second image of the clothing item worn by another person and the measurements of the subject person. The fit of the clothing item includes one or more of a garment length, a relative size of the clothing item on the other person, a draping of the clothing item on the other person, tucked in versus untucked, or sleeves rolled up versus unrolled. The processing device then displays a third image of a portrayal of the subject person wearing the clothing item with the fit portrayed in the second image. In this way, a consumer can quickly and confidently build an outfit or find clothing items, including accessories, that fit well with a realistic indication of how the clothing item will fit them.

This Summary introduces a simplified selection of concepts described below in the Detailed Description. As such, this Summary is not intended to identify essential features of the claimed subject matter or to aid in determining its scope.

### BRIEF DESCRIPTION OF THE DRAWINGS

The detailed description is described regarding the accompanying figures. Entities represented in the figures indicate one or more entities; thus, reference is made interchangeably to single or plural forms of the entities in the discussion.

FIG. 1 illustrates a digital medium environment in an example implementation that is operable to employ remote apparel fitting with the transfer of garment fit and style techniques as described herein.

FIG. 2 depicts a system in an example implementation that shows the operation of a garment fit service in greater detail employing the techniques described herein.

FIG. 3 depicts a system in an example implementation showing the operation of an image compositing module of the garment fit service of FIG. 2 in greater detail.

FIG. 4 depicts a system and procedure in an example implementation for training a machine-learning model.

FIGS. 5A through 5C depict an example user interface to employ remote apparel fitting with garment fit and style transfer.

FIG. 6 is a flow diagram depicting a procedure in an example implementation of operations performable for accomplishing a result of remote apparel fitting with the transfer of garment fit and style.

FIG. 7 illustrates an example system including various components of an example device that can be implemented as any type of computing device as described and/or utilized concerning the previous figures to implement embodiments of the techniques described herein.

### DETAILED DESCRIPTION

### Overview

Ordering clothes online can be both convenient and frustrating. On one hand, it offers unmatched convenience and the ability to browse numerous options. However, this convenience comes with its fair share of frustrations. For instance, one of the biggest challenges is being unable to physically try on the clothes before purchasing. Sizing discrepancies between brands and even different styles within the same brand make it difficult to find the right fit. Similarly, it is difficult to determine how clothing items will look even if the correct size is chosen. This often leads to the inconvenience of returning or exchanging items, incurring additional costs, and wasting time.

Furthermore, online clothes shopping is challenging because it is difficult to accurately assess color, material quality, and how clothes drape (e.g., at the shoulders or around the waist) from online photos. The limitations of digital images mean that items can look vastly different in person or on the purchaser than they did on the screen. For example, two different clothing items may appear to have a similar fit or color when viewed independently, but once matched up, the clothing items may clash or not fit well together. As a result, it is challenging to predict how clothes will fit and look without being able to try them on, which makes online clothes shopping a daunting and often disappointing experience.

Retailers and manufacturers often provide sizing charts that display a garment's measurements in different sizes. These charts typically include key measurements like chest, waist, hips, inseam, and/or sleeve length, and indicate which size (e.g., small (S), medium (M), large (L), etc.) corresponds to each range of body measurements. Sizing charts are intended to assist consumers, especially online shoppers, choose well-fitting clothes. However, sizing charts can be difficult to navigate because sizing varies across brands and body types. Because they generally focus on a few key measurements, sizing charts do not account for other factors like body shape, height, clothing design, and personal preferences.

Similarly, retailers and manufacturers often provide preview images of their clothing items, including different images of how the clothing items fit on a model or mannequin. For example, the images capture fine-grain garment fitness, such as loose on the shoulders, tight on the waist, etc. However, many online experiences make assessing the fit and style match difficult. Even if composite or comparison images are available with coarse style editing (e.g., tucking in), it is still difficult to determine the fine-grain fit of different clothing items for a particular shopper.

In contrast, the described techniques for remote apparel fitting with the transfer of garment fit and style give online shoppers greater confidence in selecting clothing items and sizes that fit well and match their preferences. Together with measurement details of the selected clothing item, a machine-learning model generates an image or three-dimensional representation of a clothing item on a digital representation of the shopper. In addition, the described techniques transfer the fine-grain fitness and style of the clothing item from an exemplar image to the digital representation of the shopper wearing the clothing item. For example, the transferred styles includes tuck in or out, garment length, sleeve roll up or down, looseness or tightness at different parts of the body, and relative garment size. In this way, users can make online purchases more confidently, find clothes that fit them better, and reduce the need to return purchases.

The following discussion describes an example environment that employs the techniques described herein. Example procedures are also described as performable in the example environment and other environments. Consequently, the performance of the example procedures is not limited to the example environment, and the example environment is not limited to the performance of the example procedures.

### Example Remote Fitting With Garment Fitness Environment

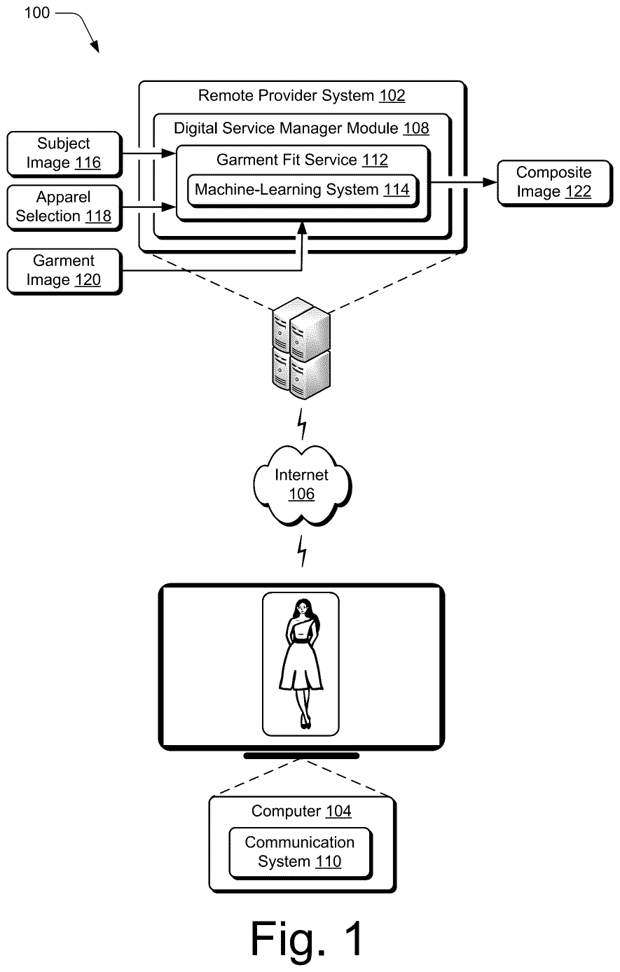

FIG. 1 illustrates a digital medium environment 100 in an example implementation that is operable to employ remote apparel fitting with the transfer of garment fit and style techniques as described herein. The illustrated digital medium environment 100 includes a remote provider system 102 and a computer 104 that are communicatively coupled, one to another, via the Internet 106 or another wired or wireless network. Computing systems for the remote provider system 102 and the computer 104 are configurable in various ways. For instance, computer 104 is associated with a user, and remote provider system 102 is a remote computing system (e.g., one or more servers) configured to employ the described techniques and systems for remote apparel fitting and garment layering.

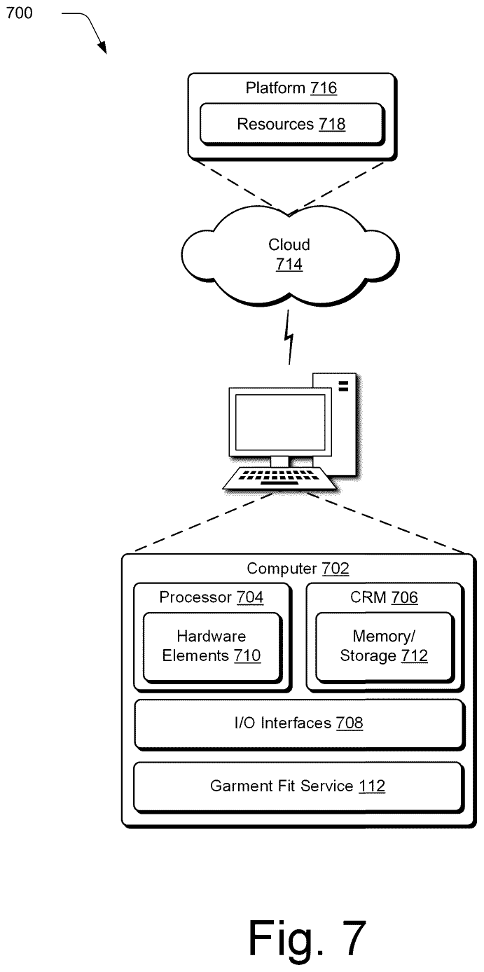

A computing system, for instance, is configurable as a desktop computer, laptop computer, mobile device (e.g., assuming a handheld configuration such as a tablet or mobile phone), server, and so forth. Thus, the remote provider system 102 or the computer 104 can range from a full-resource device with substantial memory and processor resources (e.g., servers and personal computers) to a low-resource device with limited memory and/or processing resources (e.g., some mobile devices). Additionally, although a single computing device is shown for the computer 104 and described in instances in the following discussion, a computing system is also representative of a plurality of different devices, such as multiple servers utilized by a business to perform operations “over the cloud” for the remote provider system 102 and as further described in relation to FIG. 7.

The remote provider system 102 includes a digital service manager module 108 implemented using hardware and software resources (e.g., a processing device and computer-readable storage medium) to support one or more digital services (e.g., an online marketplace). The digital services are made available remotely via the Internet 106 to computing devices (e.g., computer 104).

The digital services are scalable through implementation by the hardware and software resources and support a variety of functionalities, including accessibility, verification, real-time processing, analytics, load balancing, and so forth. Examples of digital services include a social media service, online marketplace, streaming service, digital content repository service, content collaboration service, and so on. Accordingly, in the illustrated example, a communication system 110 (e.g., browser, network-enabled application, and so on) is utilized by the computer 104 to access digital services via the Internet 106. The result of processing using the digital services is then returned to the computer 104 via the Internet 106.

In the illustrated digital medium environment 100, the digital services include a garment fit service 112 for assisting online purchasers in finding clothes and sizes that fit well to make more informed purchasing decisions. For example, the garment fit service 112 uses a machine-learning system 114 to process a subject image 116, an apparel selection 118, and a garment image 120 to generate a composite image 122. Given a subject image 116 capturing an image of the purchaser (or another consumer), the garment fit service 112 generates the composite image 122 that includes a digital representation of the purchaser in the selected clothing item and an image of its fit on the purchaser. The garment image 120 provides an example image or photograph of a person or mannequin wearing the apparel selection 118. The garment fit service 112 captures the fine-grain garment fit and style (e.g., looseness on the shoulder and tightness on the waist) of the apparel selection 118 from the garment image 120 and transfers those details to the composite image 122. In one implementation, the garment fit service 112 readily depicts the purchaser with alternate sizes or clothing items, upon the user's interaction with a user interface (UI) of the computer 104. Visually, the garment fit service 112 swaps the original clothing in subject image 116 with different clothing items realistically and plausibly and indicates their fit on the user and how the different clothing items look on the user.

As previously described, conventional online marketplaces generally just provide a sizing chart with limited measurements to assist users in selecting an appropriate size and/or determining if the clothing item will fit the user as desired. In the described remote apparel fitting with the transfer of garment fitness and styles techniques, however, image compositing gives users greater confidence in selecting clothing sizes and items that fit them well and match a desired style.

To do so, the garment fit service 112 is configurable to employ the machine-learning system(s) 114 to determine a user's dimensions (e.g., chest size, shoulder width, etc.) from a single uploaded image (e.g., the subject image 116). The user's dimensions are used to generate a mesh model and an initial composite image of the user wearing the selected clothing item(s). This machine-learning system 114 also uses garment image 120 to generate one or more composite images 122 that display the selected clothing items on the mesh model representation of the user. The composite image 122 provides a digital representation of the user (based on the subject image 116) or a mannequin wearing the selected clothing item with similar body proportions. The composite image 122 also indicates the fit and visual appearance of the clothing items on the digital representation of the user. Further discussion of these and other examples is included in the following section and shown in the corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Digital Fitting With Garment Fit and Style Transfer

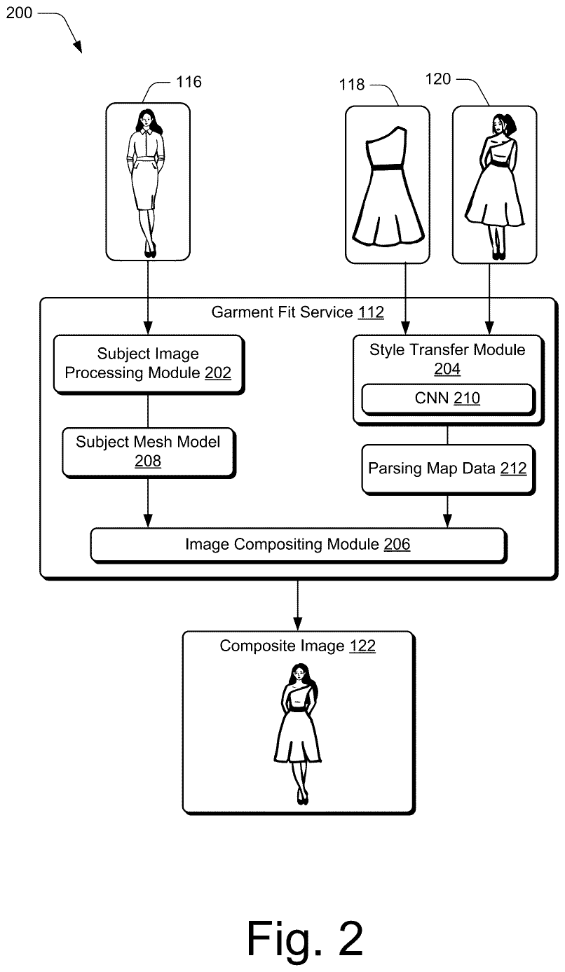

FIG. 2 depicts a system 200 in an example implementation that shows the operation of a garment fit service 112 of FIG. 1 in greater detail employing the techniques described herein. The garment fit service 112 is configurable to implement a pipeline to support the generation of a composite figure that indicates how clothing items fit on a subject. To do so, the garment fit service 112 employs a subject image processing module 202, a style transfer module 204, and an image compositing module 206.

The subject image processing module 202 is configured to process the subject image 116 to generate a subject mesh model 208. In particular, the subject image processing module 202 uses a machine-learning model to extract the subject's measurements (e.g., chest width, torso length, etc.) from the subject image 116 and generate the subject mesh model 208. The subject mesh model 208 is proportioned to match the extracted or determined measurements of the subject.

For example, the subject image processing module 202 uses a skinned multi-person linear (SMPL) model to generate the subject mesh model 208. An SMPL model is a parametric three-dimensional (3D) body model that utilizes machine learning. SPML models use a blend of linear skinning and blend shapes to represent a wide range of human body shapes and poses. Linear skinning uses weights to deform a base mesh according to a skeleton, allowing for basic body movements. Blend shapes are pre-defined shapes added to the base mesh to capture details like muscle bulges. The SMPL model of the subject image processing module 202 captures various body shapes using a relatively small number of parameters to represent complex body shapes, making it efficient for storage and real-time processing.

The parameters that control the weights and blend shapes in SMPL models are learned from a large dataset of 3D body scans, allowing them to represent a statistically realistic range of human body shapes. Here, the SMPL model is further trained on two-dimensional (2D) images or photographs of individuals to be able to generate body meshes (e.g., the subject mesh model 208) from uploaded images (e.g., the subject image 116), including a single uploaded image. The SMPL model learns the statistical relationships between the pose, shape, and appearance of the human body in the 2D images. The learned parameters are then used to define the weights and blend shapes within the SMPL model.

The subject mesh model 208 is a 3D representation of the human body (e.g., the subject in the subject image 116) made up of polygons (e.g., triangles). The polygons connect to form a surface that defines the shape and volume of the body. The subject mesh model 208 provides a realistic body shape for the subject (e.g., consumer) to allow their measurements to be extracted or determined for remote apparel fitting.

Low-poly models use fewer polygons, making them better suited for real-time applications where performance is important. High-poly models have a much higher polygon count, resulting in finer details and a more realistic appearance, but they require more processing power to render. Static meshes represent a fixed pose of the human body, while rigged meshes have a skeletal structure embedded within them, allowing for animation and various poses. In some variations, mesh models are textured with images (e.g., skin textures) to add details and realism. The subject image processing module 202 selects between low-poly and high-poly models based on available computing resources in one implementation. The generation of the subject mesh model 208 is described in greater detail in U.S. patent application Ser. No. 18/787,363, filed on Jul. 29, 2024, and is hereby incorporated in its entirety herein.

The style transfer module 204 is configured to analyze, using a convolutional neural network 210, the apparel selection 118 and garment image 120 to generate and look up parsing map data 212. Measurements and dimensions of the clothing item the user selects are generally known by the garment fit service 112 or readily available for lookup by the style transfer module 204. In one implementation, the style transfer module 204 looks up at least some of the parsing map data 212 (e.g., a minimum set of measurements) for the apparel selection 118 and extrapolates or determines other parsing map data 212 based on the garment image 120. The parsing map data 212 includes different measurements (e.g., sleeve length, wrist diameter, neck opening diameter, torso length, inseam, waist circumference) and characteristics (e.g., stretchiness, material, drape, color) of the apparel selection 118.

The style transfer module 204 uses the garment image 120 to capture fine-grain garment fit and style attributes of the apparel selection 118 (e.g., loose on the shoulder and tight on the waist) and transfer the corresponding information to the example image of the subject person wearing the apparel selection 118 (e.g., the composite image 122). In one implementation, the convolutional neural network 210 segments the garment image 120 into different parts or regions, including different body parts, different clothing items, and different portions thereof, to analyze the style and fit of the apparel selection 118 on different portions of the body.

The parsing map data 212 generated by the convolutional neural network 210 includes the garment's relative size and fit for the example model in garment image 120. Given how a human model wears the garment in garment image 120, the convolutional neural network 210 extracts a relative correlation between the garment shape and the body shape in garment image 120 as a style code. The convolutional neural network 210 then transfers the style code to an example body (e.g., the subject mesh model 208 or an example mesh model) to generate a human parsing map. The human parsing map reflects the garment's appearance and fit on an example body. In this way, the style transfer module 204 encodes the parsing map data 212 with geometric constraints to retain the fit and style exemplified by the garment image 120. A gap-filling mechanism can also be adapted to enhance the parsing map data 212 obtained from the garment image 120. Because the style transfer module 204 efficiently captures the shape, fit, and relative length of the apparel selection 118 in the garment image 120, the garment fit service 112 generates the composite image 122 of the subject person wearing the apparel selection 118 in the style and fit intended by the designer or manufacturer.

Outputs of the subject image processing module 202 (e.g., the subject mesh model 208) and the style transfer module 204 (e.g., parsing map data 212) are then received as inputs by the image compositing module 206 to generate the composite image 122. In particular, the image compositing module 206 is employed to render the subject based on the subject mesh model 208 in relation to the parsing map data 212 to indicate the apparel's fit and style on the subject. Compared with conventional techniques, the garment fit service 112 exhibits improved remote fitting to improve online shopping experiences and reduce the hassle associated with poor fitting purchases.

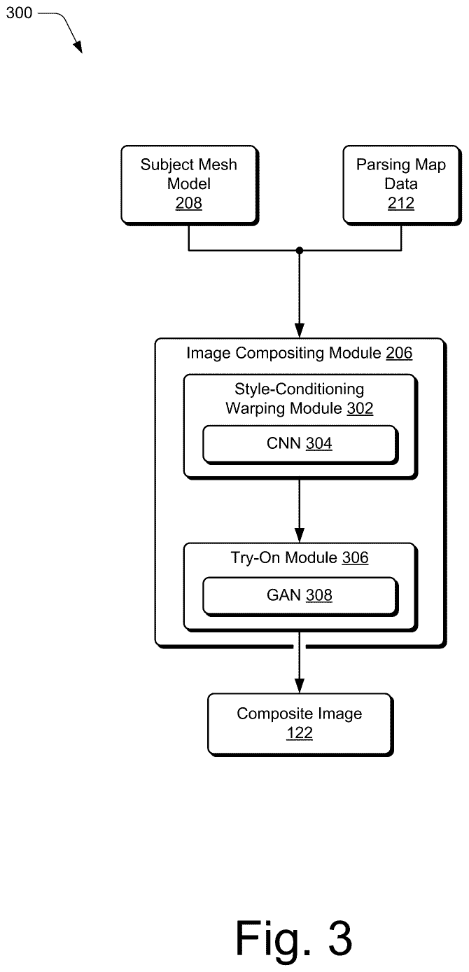

FIG. 3 depicts a system 300 in an example implementation showing the operation of an image compositing module 206 of the garment fit service 112 of FIG. 2 in greater detail. The image compositing module 206 includes a style-conditioning warping module 302, which includes a convolutional neural network (CNN) 304, and a try-on module 306, which includes a generative adversarial network (GAN) 308.

The image compositing module 206 receives as inputs the subject mesh model 208 and the parsing map data 212. The style-conditioning warping module 302 renders the apparel selection 118 on the subject mesh model 208 based on the parsing map data 212 output by the style transfer module 204. In particular, the convolutional neural network 304 uses the parsing map data 212 to warp and fit the apparel selection 118 to the subject mesh model 208 consistent with the fit and style reflected in the garment image 120. The convolutional neural network 304 is trained using parsing map data 212 from unpaired data sets. In one implementation, the convolutional neural network 304 of the style-conditioning warping module 302 is trained independently from the convolutional neural network 210 of the style transfer module 204. The independent training of the convolutional neural network 304 ensures the style-conditioning warping module 302 accurately deforms or warps the flat garment from the apparel selection 118 onto the subject mesh model 208.

The try-on module 306 generates the final remote fitting result of the warped garment on the subject person. The try-on module 306 uses the generative adversarial network 308 to synthesize the style-conditioning warped garment output by the style-conditioning warping module 302 on the subject mesh model 208 to obtain photo-realistic results in the composite image 122. The generative adversarial network 308 uses a spatially adaptive normalization (SPADE) technique to improve the image generation quality of the image-to-image translation of the subject image 116 and the garment image 120 to the composite image 122.

The generative adversarial network 308 receives as inputs the semantic segmentation map of the warped garment and uses it to adaptively normalize the activations of the convolutional layers in the generator network. The adaptive normalization allows the generative adversarial network 308 to better capture the spatial details and structure of the warped garment as it overlaps and fits on the subject mesh model 208. The normalized parameters (e.g., gamma and beta) are modulated by the semantic segmentation map, enabling the generative adversarial network 308 to control the style and appearance of the composite image 122 based on the semantic information. The try-on module 306 also uses a loss function on the skin map to enhance the skin synthesis for the composite image 122. The generative adversarial network 308 is also robust to occlusion (e.g., caused by hair, arms, etc.) in the subject image 116 or the garment image 120 and can fill in the missing information during the synthesis process.

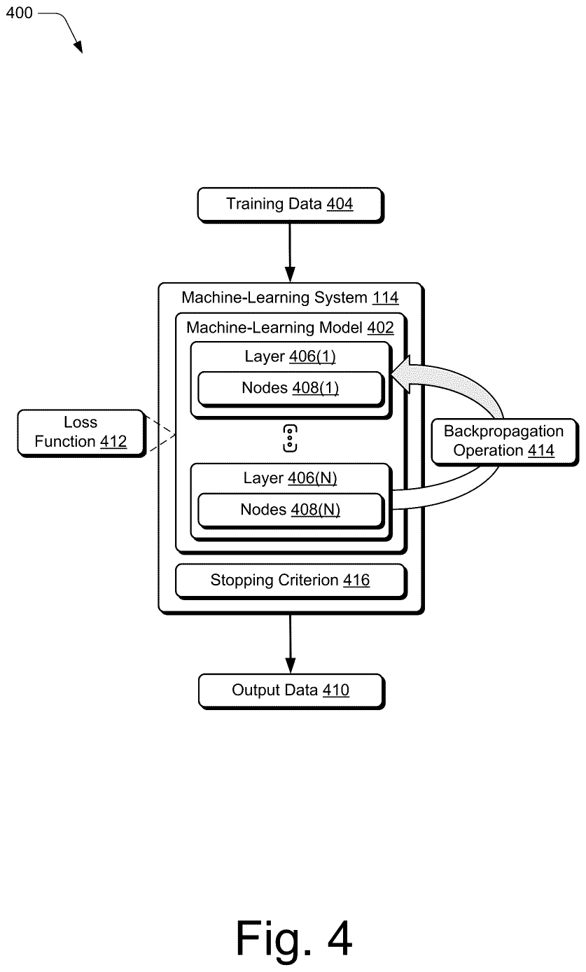

FIG. 4 depicts a system and procedure in an example implementation 400 for training a machine-learning model 402 as part of the machine-learning system 114 of FIG. 1. The machine-learning model 402 is illustrated as implemented as part of the machine-learning system 114. The machine-learning system 114 is representative of functionality to generate training data 404, use the generated training data 404 to train the machine-learning model 402, and/or use the trained machine-learning model 402 as implementing the functionality described herein.

A machine-learning model 402 refers to a tunable computer representation (e.g., through training and retraining) based on inputs without being actively programmed by a user to approximate unknown functions, automatically and without user intervention. In particular, the term machine-learning model includes a model that utilizes algorithms to learn from and make predictions on known data by analyzing training data to learn and relearn to generate outputs that reflect patterns and attributes of the training data. Examples of machine-learning models include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

In this context, the machine-learning model 402 employs a diffusion model. A “diffusion model” is a generative machine-learning model for digital content creation (e.g., composite images 122). To train the diffusion model, noise is added to training data samples until the data within the training data samples is obscured. The diffusion model is then trained self-supervised to reverse this process based on training data with a text prompt describing the digital content to be created to generate data samples as the digital content corresponding to the text prompt. To train the diffusion model, the underlying machine-learning model 402 is provided with training data 404 that includes examples of images to train and retrain the model to predict the image to be generated.

In one implementation, the machine-learning model 402 also employs a parametric model. A parametric model uses a fixed number of parameters to represent the data (e.g., mesh models) it describes. In other words, these parameters act as the knobs turned to adjust the model's fit to the data. Parametric models use a finite or predetermined set of parameters. Because they have a fixed number of parameters, parametric models are often simpler to train and require less data than non-parametric models.

In the illustrated example, the machine-learning model 402 is configured using a plurality of layers 406(1), . . . , 406(N) having, respectively, a plurality of nodes 408(1), . . . , 408(N). The plurality of layers 406(1)-406(N) are configurable to include an input layer, an output layer, and one or more hidden layers. Calculations are performed by the nodes 408(1)-408(N) within the layers via hidden states through a system of weighted connections that are “learned” during training to implement a variety of tasks (e.g., caption generation).

To train the machine-learning model 402, training data 404 is received that provides examples of “what is to be learned” by the machine-learning model 402, i.e., as a basis to learn patterns from the data. As described above, the training data 404 includes training sample pairs. For each garment, example images of people wearing the garment are collected with similar wearing styles. The images are then decomposed into pairs and used as training data 404 for the style-transferring process. The training data 404, for example, includes a large-scale dataset with a large number of images with high image resolution to assist with training and validation purposes.

The machine-learning model 402, for instance, collects and preprocesses the training data 404 that includes input features and corresponding target labels, i.e., of what is exhibited by the input features. The machine-learning system 114 then initializes the parameters of the machine-learning model 402, which the machine-learning system 114 uses as internal variables to represent and process information during training and represent interferences gained through training. In an implementation, the training data 404 is separated into batches to improve the processing and optimization efficiency of the parameters during training.

The training data 404 is then received as input and used to generate predictions based on the current state of parameters of layers 406(1)-406(N) and corresponding nodes 408(1)-408(N) of the model. The machine-learning model 402 outputs its result as output data 410. Output data 410 describes an outcome of the task (e.g., generating a composite image).

Training the machine-learning model 402 includes calculating a loss function 412 to quantify a loss associated with operations performed by nodes 408 of the machine-learning model 402. For instance, calculating the loss function 412 includes comparing a difference between predictions specified in the output data 410 with target labels specified by the training data 404. The loss function 412 is configurable in various ways, including regression, the quadratic loss function as part of a least squares technique, and so forth.

Calculating the loss function 412 also includes using a backpropagation operation 414 to minimize the loss function 412, thereby training the parameters of the machine-learning model 402. Minimizing the loss function 412 includes adjusting the weights of the nodes 408(1)-408(N) to minimize the loss and thereby optimize the performance of the machine-learning model 402 for a particular task. The adjustment is determined by computing a gradient of the loss function 412, which indicates a direction to be used to adjust the parameters for minimizing the loss. The parameters of the machine-learning model 402 are then updated based on the computed gradient.

This process continues over several iterations until a stopping criterion 416 is met. The stopping criterion 416 is employed by the machine-learning system 114 in this example to reduce overfitting of the machine-learning model 402, reduce computational resource consumption, and promote an ability to address previously unseen data, i.e., that is not included specifically as an example in the training data 404. Examples of a stopping criterion 416 include but are not limited to a predefined number of epochs, validation loss stabilization, achievement of a performance improvement threshold, or based on performance metrics such as precision and recall.

### Example Remote Apparel Fitting Procedures

The following discussion describes techniques for remote apparel fitting with the transfer of garment fit and style that are implementable utilizing the described systems and devices. Aspects of each procedure are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions, thereby creating a special-purpose machine for carrying out an algorithm as illustrated by the flow diagram. As a result, the instructions are stored on a computer-readable storage medium that causes the hardware to perform the algorithm, e.g., responsive to the execution of the instructions. In portions of the following discussion, reference will be made to FIGS. 1-4.

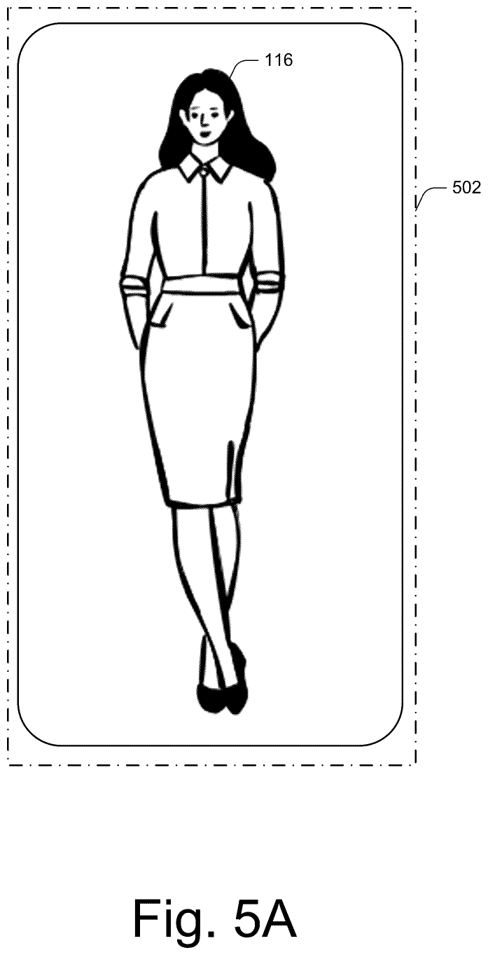

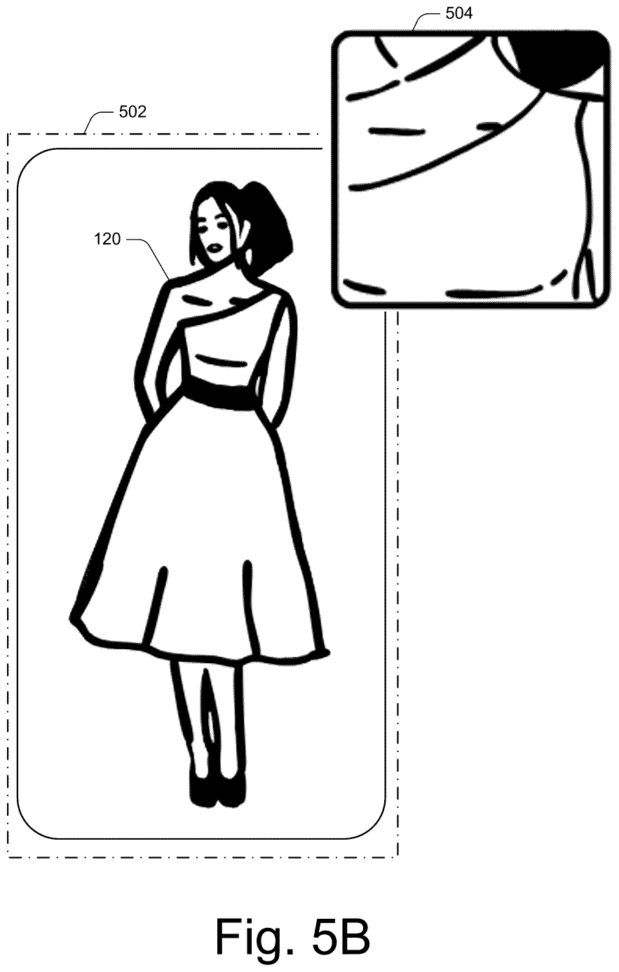

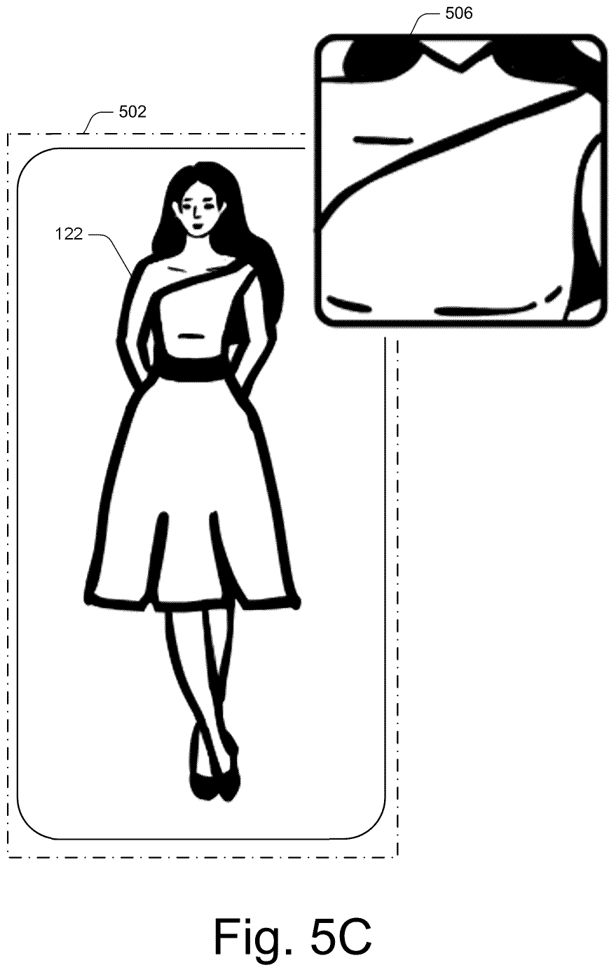

FIGS. 5A through 5C depict an example user interface 502 to employ remote apparel fitting with the transfer of garment fit and style. The user interface 502 includes a subject image 116, a garment image 120, and a composite image 122 in FIGS. 5A-5C, respectively. In other implementations, the user interface 502 includes additional or fewer components, including an option to change the apparel selection's size, color, or pattern.

In FIG. 5A, the subject image 116 represents the subject (e.g., online purchaser) wearing a random garment. The subject uploads or selects the subject image 116 from memory associated with the user's electronic device or the clothing application. In one implementation, the subject image 116 includes a front view of the subject, but different-facing views are provided in different implementations.

In FIG. 5B, the garment image 120 represents a model or example person wearing the apparel selection 118. The model representation can include a mannequin wearing the apparel selection 118 in one implementation. The garment image 120 provides an example of the designer's intended fit and style of the apparel selection 118. Blow-out 504 provides a zoomed-in look at the fit and style of the dress as it wraps over the model's shoulder. The blow-out 504 is an example segmentation that the convolutional neural network 304 of the style-conditioning warping module 302 collects to ensure proper fit and style transfer to the subject person.

In FIG. 5C, the composite image 122 represents the subject (e.g., online purchaser) wearing the apparel selection 118. The subject representation can include a mannequin image with body proportions based on the subject mesh model 208. In other implementations, the subject representation reproduces the user based on the subject image 116. In FIG. 5C, the composite image 122 includes a front-facing view of the subject person, but different-facing views are provided in different implementations. In other implementations, the composite image 122 can be rotated or seen from different perspectives.

In FIG. 5C, a blow-out 506 provides a zoomed-in look at the fit and style of the dress as it wraps over the subject's shoulder. The blow-out 506 is an example segmentation that the generative adversarial network 308 of the try-on module 306 uses to ensure proper fit and style transfer to the subject person. As a result, the garment fit service 112 provides a realistic and accurate transfer of the dress'fit and style from the model in the garment image 120 to the subject person in the composite image 122, providing the subject with greater confidence in making an online purchasing decision for the selected dress.

In example implementations, the user interface 502 includes an informational element with a “Build Your Look” feature with the option for the user to add additional apparel to the composite image 122 to assist with the purchasing decision for the apparel selection 118 or find additional clothing items for purchase. The informational element can include a clothing item selection, color or pattern selection, size selection, and an “Add to Cart” button.

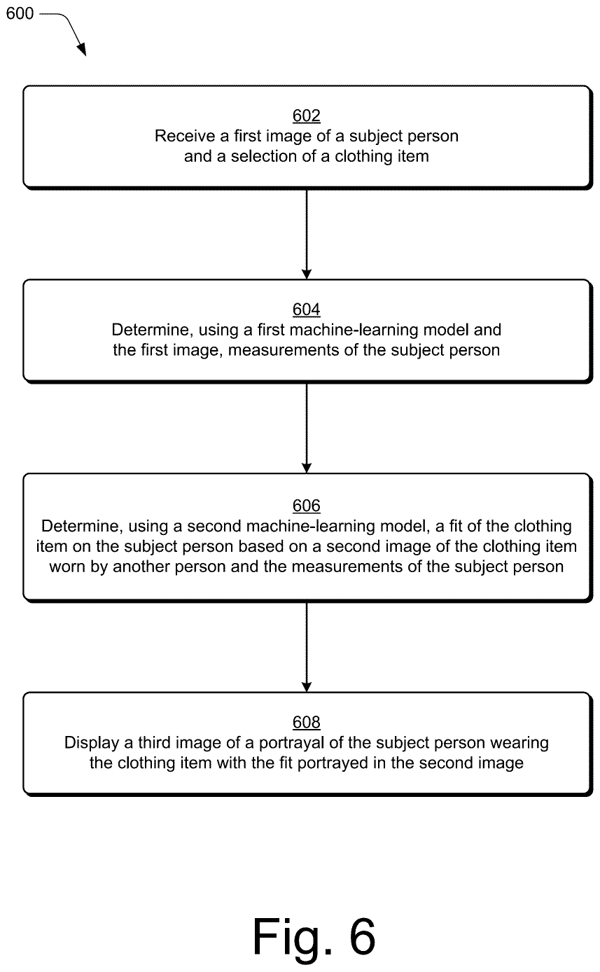

FIG. 6 is a flow diagram depicting a procedure 600 in an example implementation of operations performable for accomplishing a result of remote apparel fitting with the transfer of garment fit and style. To begin, a first image of a subject person and a selection of a clothing item is received (block 602). For example, the garment fit service 112 receives a subject image 116 of the user (or another person) and an apparel selection 118 of a clothing item for the user to try on remotely. The apparel selection 118 may also indicate a selected size of the clothing item for the remote apparel fitting.

A first machine-learning model is used to determine measurements of the subject person based on the first image (block 604). The measurements relate or correspond to the dimensions of the apparel selection 118. For example, the first machine-learning model is a parametric model (e.g., SPML model) that generates a representation of the subject person using a human mesh model with the measurements of the subject person.

A second machine-learning model is then used to determine a fit of the clothing item on the subject person (block 606). The fit is determined based on a second image of the clothing item worn by another person and the measurements of the subject person. The fit of the clothing item includes a garment length, a relative size of the clothing item on the other person, a draping of the clothing item on the other person, tucked in versus untucked, or sleeves rolled up versus unrolled.

In one implementation, the second machine-learning model also uses the clothing item's dimensions (e.g., shoulder width, waist circumference, inseam length, hip circumference, sleeve length, sleeve circumference, collar opening diameter, chest width, chest diameter), which are determined or looked up by the processing device. In one implementation, the second machine-learning model includes a convolutional neural network that transfers the fit of the clothing item in the second image to a portrayal of the subject person wearing the clothing item. The second machine-learning model is trained using pairs of images of different persons wearing different garments to learn to transfer the fit of the garments between people.

To determine the fit of the clothing item, the second machine-learning model extracts a relative correlation between a shape of the clothing item and a body shape of the other person in the second image as a style code. The second machine-learning model then transfers the style code to obtain a parsing map that reflects how the clothing item fits on a human body. The parsing map provides geometric constraints to retain the fit of the clothing item from the second image.

A determination of the fit of the clothing item further includes using a third machine-learning model to generate a warped clothing item from a flat representation of the clothing item to indicate how the clothing item fits on different parts of a human body. The warping is performed using the parsing map as a guide. In one implementation, the third machine-learning model includes a convolutional neural network and a transformer that is trained independently from the second machine-learning model using parsing maps from unpaired data.

A third image of a portrayal of the subject person wearing the clothing item with the fit portrayed in the second image is displayed (block 608). For example, the processing device includes a generative adversarial network or a generative diffusion model that generates a reproduced image of the subject person wearing the clothing item that transfers the fit and style of the apparel selection 118 from garment image 120 to composite image 122. In one implementation, the image of the subject person is projected onto the human mesh model to generate the portrayal of the subject person, and the warped clothing item is projected or synthesized onto the reproduced image of the subject person.

In another implementation, the third image may include a fit representation that indicates a looseness or tightness of the clothing item in multiple locations vis-à-vis the measurements of the subject person. The fit representation can be a heat map (e.g., grayscale or color) with a fitting key in one implementation. The processing device can also provide a textual summary of the fit or a suggestion for a better fit for a different size or clothing item. In one implementation, the reproduced image is three-dimensional or rotatable to allow views of the clothing fit from different perspectives.

### Example System and Device

FIG. 7 illustrates an example system 700, which includes an example computer 702 that represents one or more computing systems and/or devices usable to implement the techniques described herein. This is illustrated through the inclusion of the garment fit service 112. The computer 702 is configurable, for example, as a service provider server, a device associated with a client (e.g., a client device, mobile device, laptop, desktop computer, tablet, notepad), an on-chip system, and/or any other suitable computing device or computing system.

The example computer 702, as illustrated, includes a processor 704, one or more computer-readable media 706, and one or more I/O interfaces 708 that are communicatively coupled, one to another. Although not shown, the computer 702 includes a system bus or other data and command transfer system that couples the various components. For example, a system bus includes any combination of different bus structures, such as a memory bus or controller, a peripheral bus, a universal serial bus, and/or a processor or local bus that utilizes various bus architectures. Various other examples are also contemplated, such as control and data lines.

The processor 704 represents the functionality to perform one or more operations using hardware. Accordingly, processor 704 is illustrated as including hardware elements 710 that are configured as processors, functional blocks, and so forth. This includes example implementations in hardware, such as an application-specific integrated circuit or other logic device formed using one or more semiconductors. The hardware elements 710 are not limited by the materials from which they are formed or the processing mechanisms employed therein. For example, processors are comprised of semiconductor(s) and/or transistors (e.g., electronic integrated circuits (ICs)). In such a context, processor-executable instructions are, for example, electronically-executable instructions.

The computer-readable media 706 is illustrated as including memory/storage 712. Memory/storage 712 represents memory or storage capacity associated with one or more computer-readable media. In one example, the memory/storage 712 includes volatile media (such as random access memory (RAM)) and/or nonvolatile media (such as read-only memory (ROM), Flash memory, optical disks, magnetic disks, and so forth). In another example, the memory/storage 712 includes fixed media (e.g., RAM, ROM, a fixed hard drive, and so on) and removable media (e.g., Flash memory, a removable hard drive, an optical disc, and so forth). The computer-readable media 706 is configurable in various ways, as described below.

Input/output interface(s) 708 are representative of functionality to allow a user to enter commands and information to computer 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which employs visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, computer 702 is configurable in various ways to support user interaction, as further described below.

Various techniques are described in the general context of software, hardware elements, or program modules. Generally, such modules include routines, programs, objects, elements, components, data structures, and so forth that perform particular tasks or implement abstract data types. The terms “module,” “functionality,” and “component” as used herein generally represent software, firmware, hardware, or a combination thereof. The features of the techniques described herein are platform-independent, meaning that the techniques are implementable on various commercial computing platforms with various processors.

Implementations of the described modules and techniques are stored on or transmitted across some form of computer-readable media. For example, the computer-readable media includes a variety of media accessible to the computer 702. By way of example, and not limitation, computer-readable media includes “computer-readable storage media” and “computer-readable signal media.”

“Computer-readable storage media” refers to media and/or devices that enable persistent and/or non-transitory information storage in contrast to mere signal transmission, carrier waves, or signals per se. Thus, computer-readable storage media refers to non-signal-bearing media. The computer-readable storage media includes hardware such as volatile and non-volatile, removable and non-removable media, and/or storage devices implemented in a method or technology suitable for storage of information such as computer-readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which are accessible to a computer.

“Computer-readable signal media” refers to a signal-bearing medium configured to transmit instructions to the hardware of the computer 702, such as via a network. Signal media typically embodies computer-readable instructions, data structures, program modules, or other data in a modulated data signal, such as carrier waves, data signals, or other transport mechanisms. Signal media also includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic, and/or fixed device logic implemented in a hardware form that is employable in some examples to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware and hardware utilized to store instructions for execution, e.g., the computer-readable storage media described previously.

Combinations of the foregoing are also employable to implement various techniques described herein. Accordingly, software, hardware, or executable modules are implementable as instructions and/or logic embodied on some form of computer-readable storage media and/or by one or more hardware elements 710. For example, the computer 702 is configured to implement particular instructions and/or functions corresponding to the software and/or hardware modules. Accordingly, implementation of a module executable by the computer 702 as software is achieved at least partially in hardware, e.g., through computer-readable storage media and/or hardware elements 710 of the processor 704. The instructions and/or functions are executable/operable by one or more articles of manufacture (for example, one or more computers 702 and/or processors 704) to implement techniques, modules, and examples described herein.

The techniques described herein are supportable by various configurations of the computer 702 and are not limited to the specific examples of the techniques described herein. This functionality is also implementable entirely or partially through a distributed system, such as over a “cloud” 714, as described below.

Cloud 714 includes and/or represents a platform 716 for resources 718. The platform 716 abstracts the underlying functionality of hardware (e.g., servers) and software resources of the cloud 714. For example, resources 718 include applications and/or data utilized while computer processing is executed on servers remote from the computer 702. In some examples, the resources 718 also include services provided over the Internet and/or through a subscriber network, such as a cellular or Wi-Fi network.

Platform 716 abstracts the resources 718 and functions to connect the computer 702 with other computing devices. In some examples, the platform 716 also serves to abstract scaling of resources to provide a corresponding level of scale to encountered demand for the resources implemented via the platform. Accordingly, in an interconnected device example, the implementation of functionality described herein is distributable throughout system 700. For example, the functionality is partially implementable on computer 702 and via platform 716, which abstracts the functionality of cloud 714.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

What is claimed is:

1. A method comprising:
receiving, by a processing device, a first image of a subject person and a selection of a clothing item;
determining, using a first machine-learning model and the first image, measurements of the subject person, the measurements relatable to one or more dimensions of the clothing item;
determining, using a second machine-learning model, a fit of the clothing item on the subject person based on a second image of the clothing item worn by another person and the measurements of the subject person; and
displaying, by the processing device via a display, a third image of a portrayal of the subject person wearing the clothing item with the fit portrayed in the second image.

2. The method of claim 1, wherein:
the first machine-learning model comprises a parametric model that generates a representation of the subject person using a human mesh model with measurements of the subject person; and
the second machine-learning model comprises a convolutional neural network that transfers the fit of the clothing item in the second image to the portrayal of the subject person wearing the clothing item in the third image.

3. The method of claim 2, wherein training data for the second machine-learning model includes pairs of images of persons wearing garments to learn to transfer the fit of the garments between the persons.

4. The method of claim 3, wherein the fit of the clothing item includes one or more of a garment length, a relative size of the clothing item on the other person, a draping of the clothing item on the other person, tucked in versus untucked, or sleeves rolled up versus unrolled.

5. The method of claim 2, wherein determining the fit of the clothing item comprises:
extracting a correlation between a shape of the clothing item and a body shape of the other person as a style code; and
transferring the style code to a parsing map that reflects how the clothing item fits on a human body, the parsing map providing geometric constraints to retain the fit of the clothing item from the second image.

6. The method of claim 5, wherein determining the fit of the clothing item further comprises generating, using a third machine-learning model, a warped clothing item from a flat representation of the clothing item based on the parsing map.

7. The method of claim 6, wherein the third machine-learning model comprises a convolutional neural network and a transformer that are trained independently from the second machine-learning model using parsing maps from unpaired data.

8. The method of claim 6, wherein the third image is generated using a generative adversarial neural network that synthesizes the warped clothing item on the portrayal of the subject person.

9. The method of claim 6, wherein the warped clothing item is further generated based on one or more dimensions of the clothing item that include at least two of shoulder width, waist width, waist circumference, inseam length, hip circumference, sleeve length, collar opening diameter, chest width, or chest diameter.

10. The method of claim 6, wherein the portrayal of the subject person is projected onto the human mesh model to generate the third image.

11. The method of claim 1, wherein the selection of the clothing item indicates a selected size of the clothing item.

12. The method of claim 10, wherein a suggestion for a different size of the clothing item or a different clothing item with a better fit is displayed along with the third image.

13. A computing device comprising:
a memory; and
a processor configured to:
receive a first image of a subject person and a selection of a clothing item;
determine, using a first machine-learning model and the first image, measurements of the subject person, the measurements relatable to one or more dimensions of the clothing item;
determine, using a second machine-learning model, a fit of the clothing item on the subject person based on a second image of the clothing item worn by another person and the measurements of the subject person; and
display, via a display, a third image of a portrayal of the subject person wearing the clothing item with the fit portrayed in the second image.

14. The computing device of claim 13, wherein:
the first machine-learning model comprises a parametric model that generates a representation of the subject person using a human mesh model with measurements of the subject person; and
the second machine-learning model comprises a convolutional neural network that transfers the fit of the clothing item in the second image to the portrayal of the subject person wearing the clothing item in the third image, training data for the second machine-learning model including pairs of images of persons wearing garments to learn to transfer the fit of the garments between the persons.

15. The computing device of claim 14, wherein the fit of the clothing item includes one or more of a garment length, a relative size of the clothing item on the other person, a draping of the clothing item on the other person, tucked in versus untucked, or sleeves rolled up versus unrolled.

16. The computing device of claim 14, wherein determining the fit of the clothing item comprises:
extracting a correlation between a shape of the clothing item and a body shape of the other person as a style code;
transferring the style code to a parsing map that reflects how the clothing item fits on a human body, the parsing map providing geometric constraints to retain the fit of the clothing item from the second image; and
generating, using a third machine-learning model, a warped clothing item from a flat representation of the clothing item based on the parsing map.

17. The computing device of claim 16, wherein the third machine-learning model comprises a convolutional neural network and a transformer that are trained independently from the second machine-learning model using parsing maps from unpaired data.

18. The computing device of claim 16, wherein the third image is generated using a generative adversarial neural network that synthesizes the warped clothing item on the portrayal of the subject person, the portrayal of the subject person being projected onto the human mesh model.

19. The computing device of claim 16, wherein the warped clothing item is further generated based on one or more dimensions of the clothing item that include at least two of shoulder width, waist width, waist circumference, inseam length, hip circumference, sleeve length, collar opening diameter, chest width, or chest diameter.

20. One or more computer-readable storage media storing instructions that, responsive to execution by a processing device, causes the processing device to:
receive a first image of a subject person and a selection of a clothing item;
determine, using a first machine-learning model and the first image, measurements of the subject person, the measurements relatable to one or more dimensions of the clothing item;
determine, using a second machine-learning model, a fit of the clothing item on the subject person based on a second image of the clothing item worn by another person and the measurements of the subject person; and
display, via a display, a third image of a portrayal of the subject person wearing the clothing item with the fit portrayed in the second image.
